(19) United States
(12) Patent Application Publication
(10) Pub. No.: US 2005/0184540 A1
(43) Pub. Date: Aug. 25, 2005

(54) Dispose a Poop

(75) Inventor: Donato Graziosi, East Northport, NY (US)

Correspondence Address: DANIEL GRAZIOSI, 7 MAGENTA LANE, EAST NORTHPORT, NY, 11731, US

(73) Assignee: Mr. Donato Graziosi, East Northport, NY (US)

(21) Appl. No.: 10/708,332

(22) Filed: Feb. 24, 2004

(51) Int. Cl. A01K 29/00; E01H 1/12

(52) U.S. Cl. 294/1.4

(57) ABSTRACT

A light weight, easy to use waste scooper with a unique disposable bag. The disposable bag is simply released into the trash by a handle on the scooper. The disposable bags are easily attached onto the scooper with touching any messy parts.

### BACKGROUND OF INVENTION

This invention relates to dog waste scooper with release handle to discard disposable bag. Today there are many types of dog scoopers on the market. Some of them are basically small shovels at right angles. These types of scoopers allow you to scoop the waste but then you have to still figure out a way to get the waste inside of a disposable bag. This can be messy since you have to hold the bag with one hand and manipulate the scooper with the other hand. Some of them have bags attached but have to be manually removed by hand, which can be messy. Also when re-installing bags you have to touch the soiled scooper. Some scoopers have claws that close which pick up the waste but still have the problem of having to put the waste in some sort of bag. Others sell just a bag which you stick your hand through, grab the waste and invert the bag. You have to be very careful when you invert the bag so that it doesn't get on your hands. This method also leaves some waste matter still on the ground. BACKGROUND OF INVENTION-OBJECTS AND ADVANTAGES Accordingly, besides the objects and advantages of the dispose a poop described in my above patent, several objects and advantages of the present invention are: (a) to provide a dog waste scooper that is light weight and easy to use; (b) to provide a dog waste scooper that is above all the rest; (c) The dispose a poop scooper can be used to scoop up dog waste that is already on the ground or while the dog is doing his business; (d) Simply scoop up the dog waste and hold the scooper over a garbage pail, squeeze the handle and the waste is disposed of in a self-sealing bag;

### SUMMARY OF INVENTION

Accordingly, the reader will see that the dispose a poop closure of this invention can be used easily to scoop up and dispose of dog waste. The unique design allows one to release a disposable bag into the trash with the squeeze of a hand. Placing a new bag onto the scooper is easily done and there is no need to touch any messy part of the scooper. The scooper can be used in 2 methods. Picking up waste that is already on the ground or picking up waste while dog is doing his business, can be very handy when walking the dog. Although the description above contains many details, which should not be construed as limiting the scope of this invention but as an illustrations of some of the preferred embodiments of this invention. For example, the scooper can be built in various sizes to accommodate different size dogs. The spring for the bag release/holder mechanism can be designed in many different ways. Thus the scope of the invention should be determined by the appended claims and their legal equivalents, rather than by the examples given.

### BRIEF DESCRIPTION OF DRAWINGS

FIG. 1 consist of the main scooper frame (1) which has a left fork (2) and a right fork (3). It is made with a lightweight metal alloy. (5) is the main scooper blade or shovel used to scoop the dog waste. (6) is the disposable bag guide. This allows the waste to slide along this guide so that the waste goes right into the disposable bag. (4) is the holder/release mechanism. The holder/release mechanism is connected to the left and right fork of the scooper frame.

The holder/release mechanism is also connected to the release handle via a cable (8), see FIG. 2. Depressing the handle (9) causes the holder/release mechanism to collapse the guides there by allowing the disposable bag (7) to fall into the trashcan. (5) is a side view of the main scooper blade. (10) is part of the main scooper and is used to aid in depressing the handle. (11) is the elastic part of the disposable bag.

FIG. 3 shows a top view of the main scooper blade or shovel (5). (2) and (3) are cut out views of the right and left fork. (4) is a top view of the holder/release mechanism. (7) is the disposable bag.

FIG. 4 shows a rear view and top view of the holder/release mechanism (4) and a bottom view. It also shows the movement of the holder/release mechanism arms as indicated by the curved arrows (11).

FIG. 5 shows a person scooping up waste (top picture) and a man disposing the waste by depressing the handle and releasing the disposable bag into the trash.

FIG. 6 shows how easy it is to attach the disposable bag onto the release/holder mechanism. The handle is squeezed thereby collapsing the release/holder arms. A bag is held over the release/holder arms and then releasing the handle forces the arms to spring back into the hold position securing the disposable bag in place.

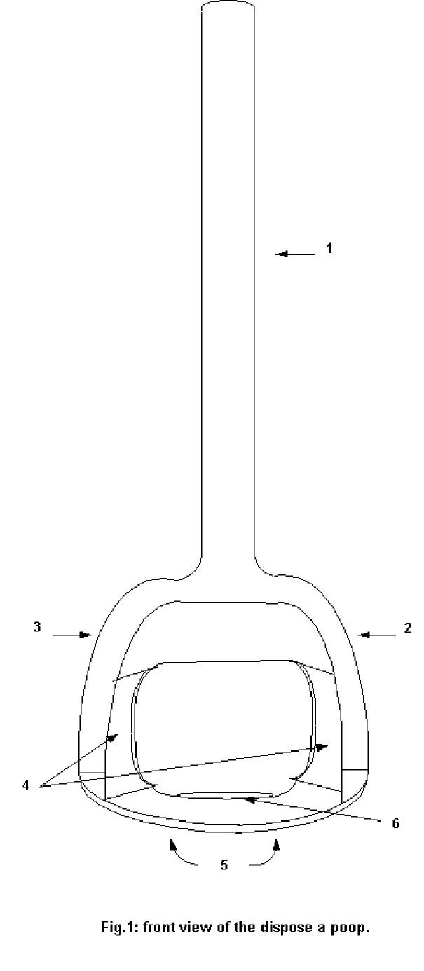

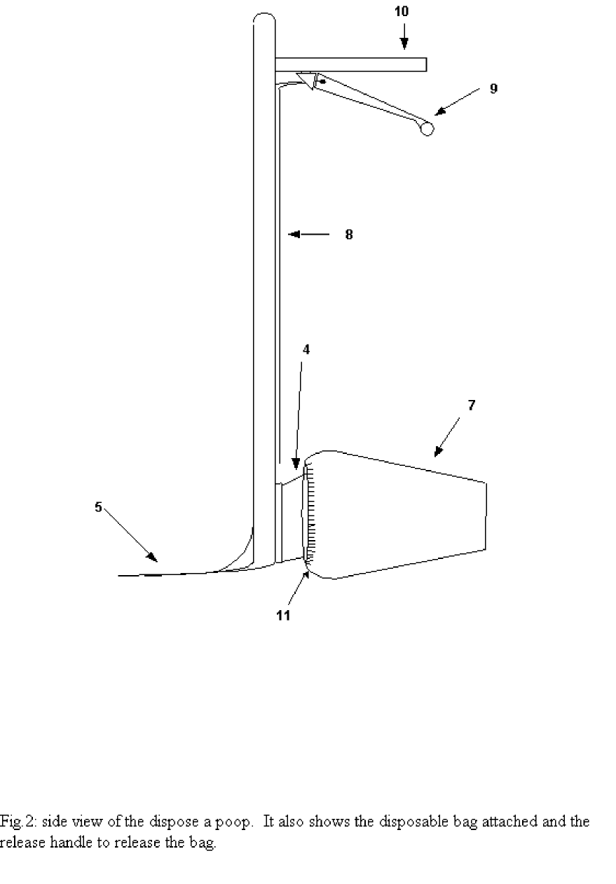

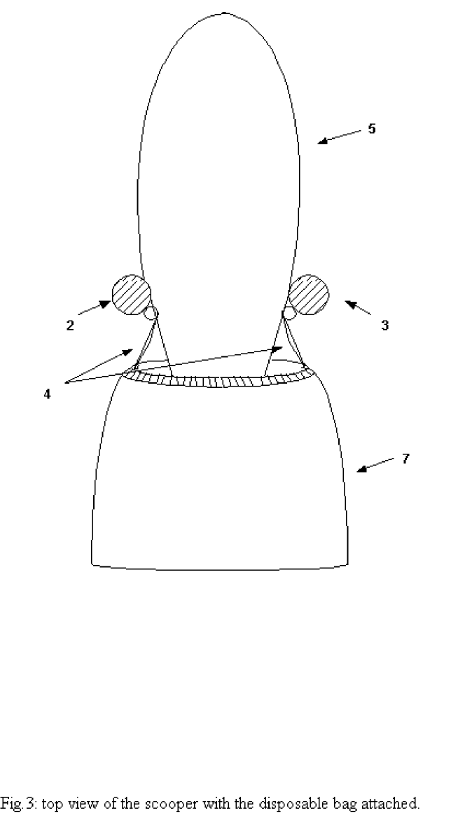

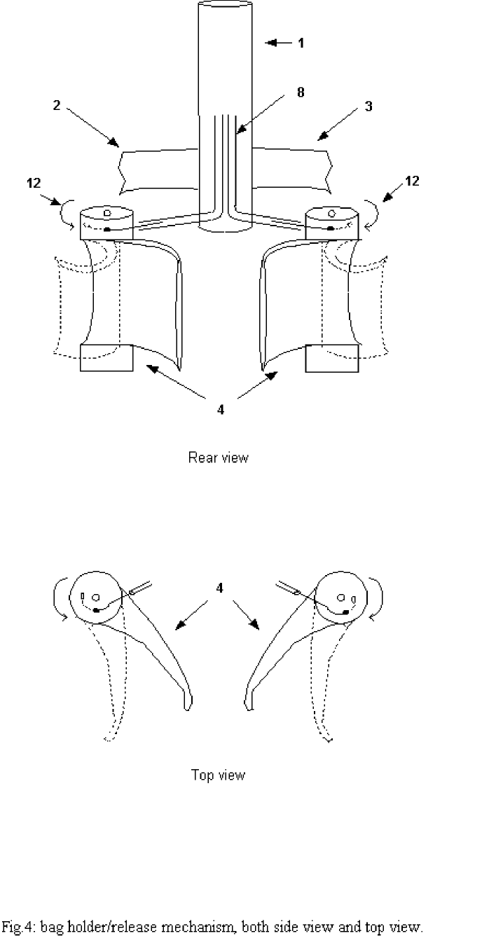

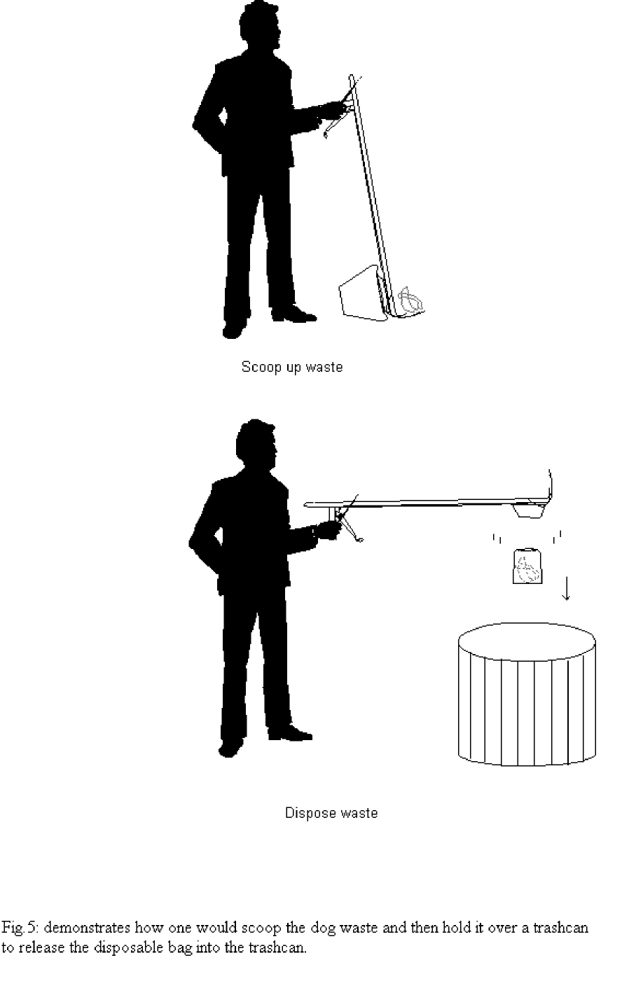

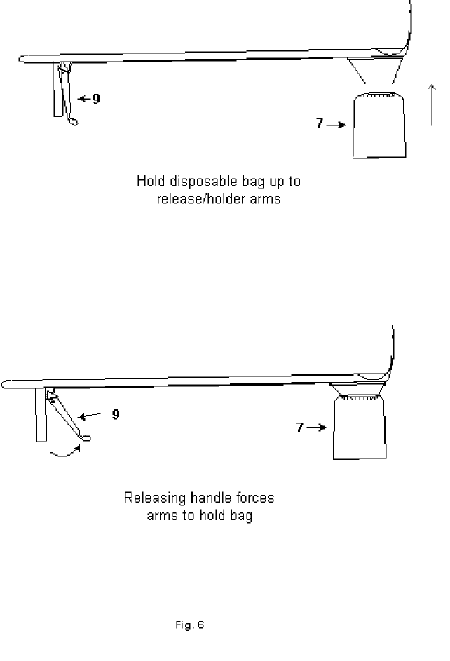

### BRIEF DESCRIPTION OF SEQUENCES

Advantages From the description above, a number of advantages of my dispose a poop become evident: (a) It's lightweight and easy to use, yet durable and will last for years. (b) The disposable bags are placed onto the scooper with one hand squeezing the handle and the other hand holding up the bag, never touching the any messy part of the scooper. (c) The waste is easily disposed of by squeezing the handle releasing the disposable bag into a trashcan, again never touching any messy part. When the disposable bag is release the elastic part of the bag shrinks the opening so that the waste stays in the bag even when it's in the trash, just in case the trash can bag were to break.

### DETAILED DESCRIPTION

The manner of the using the dispose a poop can be described in 2 ways. The first method is used to scoop up waste that is already on the ground. While holding the main frame one slides the front of the scooper blade (5) under the waste to scoop the waste allowing the waste to slide on top of the scooper blade. Next while still holding the main frame tilt the scooper so that the scooper blade is perpendicular to the ground. This will allow the waste to slide along disposable bag guide (6) and into the disposable bag (7). While holding the scooper in this position over a trashcan, the release handle (9) is squeezed which collapses the bag holder (9) and allows the disposable bag (7) to fall on its own. This works because the disposable bag is designed to remain slightly opened and the release mechanism (4) is tapered as its collapsed creating an easy slide for the disposable bag. The second method, one holds the scooper underneath the dog as the dog is doing his business. The scooper can catch the waste and disposing it would be the same steps as outline above. To attach a new disposable bag (7) simply squeeze the release handle (9) and while holding a disposable bag from the bottom place the opening of the bag over the release/holder mechanism. The disposable bag opening is larger than the holder (4). While still holding the disposable bag over the holder, release the handle (9), which allows the holder to grab onto the disposable bag by spring tension. The holder will stretch out the opening of the disposable bag so that the waste can easily slide into the disposable bag.

### DRAWINGS—REFERENCE NUMERALS

1 Main scooper frame

2 Frame right fork

3 Frame left fork

4 Bag holder/release

5 Main scooper blade

6 Disposable bag guide

7 Disposable bag

8 Release cable

9 Bag holder/release handle

10 Frame handle guide

11 Elastic part of bag

1. A method of picking up dog waste and disposing it with a manually controlled disposable bag, composing: a) a main frame with a said fixed scooper b) a disposable bag attached to said scooper with release handle to drop bag into trash. a unique mechanism used to hold said disposable bag in place and release bag by squeezing a said release handle.
